(19) United States
(12) Patent Application Publication
(10) Pub. No.: US 2004/0101298 A1
(43) Pub. Date: May 27, 2004

(54) Method for arranging cameras and mirrors to allow panoramic visualization

(75) Inventors: Robert Mandelbaum, Bala Cynwyd, PA (US); George Herbert Needham Riddle, Princeton, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/688,436

(22) Filed: Oct. 17, 2003

Related U.S. Application Data
(60) Provisional application No. 60/419,466, filed on Oct. 18, 2002.

(51) Int. Cl. G03B 41/00

(52) U.S. Cl. 396/322

(57) ABSTRACT

The invention is an apparatus for providing X-server interface to a Unix server using any television from any location that has a connection between them. Providing flexible and economical computer access to the users. This connection can be achieved using standard telephone lines, local area network, Wireless connection, an Internet Service Provider or any other communication system that can get the connection in operational status.

### BACKGROUND OF INVENTION—FIELD OF INVENTION

Apparatus and methods for providing computer user interface from an Unix server to a remote location. Using standard telephone lines or an Internet Service Provider.

### BACKGROUND OF INVENTION—DISCUSSION OF PRIOR ART

In recent years, there has been a significant expansion in the use of PC (Personal Computers) in schools, government, companies, hotels, etc. Particularly many students don't have the money to buy a computer and they need the computer skills.

A basic technology that has been in the marketplace for decades is that of terminals. Terminal technology has evolved over the years. 20 years ago a graphical user interface (GUI) was added in the form of an X-Terminal and X-Server based on the UNIX operating system.

The present invention uses simple and inexpensive X-Portable Workstation and utilizes telephone lines or an Internet Service Provider (ISP) to provide X-terminal access from relatively simple and inexpensive X-Portable Workstation.

### BACKGROUND OF INVENTION—OBJECTS AND ADVANTAGES

Several objects and advantages of the invention are:

(a) To provide the advantage of x protocol when the user from a remote computer with Unix operating system wants to use a television as a monitor giving its low cost, availability and effective use of the x protocol.

(b) To provide the output for different kind of television. The product can be customized to use a variety of television standards like NTSC, PAL, etc and television resolutions like High Definition Television (HDTV). The option of VGA output for connecting to monitors is available to cover a wider range of equipments that the customer can use or already have.

(c) The modular design gives the flexibility to use a diversity of input/output devices that can extend and provides more functionality to the x server system like keyboards, mouses, joysticks, gloves, etc.

(d) To provide full advantage of the communication system used in the present, the modularity of the invention gives the facility to connect to remote computers using a variety of systems like Ethernet, modem etc.

(e) To provide secure connection the option of storage device like floppy disk, flash card, CD, etc. Have been included to facilitate the configuration and security of the connection to the remote server.

(f) The operating system used by the invention is any UNIX base operating system or any other operating system that can run a X terminal program. This operating system is referred as Linux embedded system due to its location at an embedded device, and giving access to applications on Unix base operating system servers like Linux, Solaris, etc.

(g) The x-portable workstation can have the option of receiving television video signal in one of the inputs, then said workstation can mix this video signal with the video signal from the remote computer creating an effect of picture in picture in the television screen. For example, this feature gives the user the ability to watch a television show and at the same time, in the same television, be able to work with programs in the remote computer. This ability to communicate between the television audience and the television shows providers create new possibilities to the entertainment and commercialization of the television services.

### SUMMARY

The invention is an X-terminal access system, which provides economical computer access from multiple locations using an existing telephone infrastructure or Internet. The invention comprises an X-Portable Workstation connected by telephone or Internet Service (ISP, DSL, cable modem, etc) to a UNIX server. The term X-Portable Workstation comprising a display output, audio output, and telephone line interface circuitry (e.g., a DSL modem) or other Internet server connection (e.g. Network card), and user-input devices such as a joystick, keyboard and a mouse. The display output can be a video output compatible with television, high definition television (HDTV) or a computer monitor like Video Graphic Array (VGA).

The invention can be added a different protocol or use the same already created to be used as a remote game's console.

### DRAWING—FIGURES

FIG. 1 Illustrate the Unix server connected to multiple clients' X-Portable Workstation using modem or Internet and the connection to television, monitor, keyboard, mouse and joystick

FIG. 2 Shows a block diagram of the X-Portable Workstation.

### DRAWING—LIST OF REFERENCES NUMERALS

FIG. 1 illustrates a Unix server connected to multiple clients X-Portable Workstation using any possible connection to the Unix server and the local connection to television, monitor, keyboard, mouse and joystick.

FIG. 1-1 Television

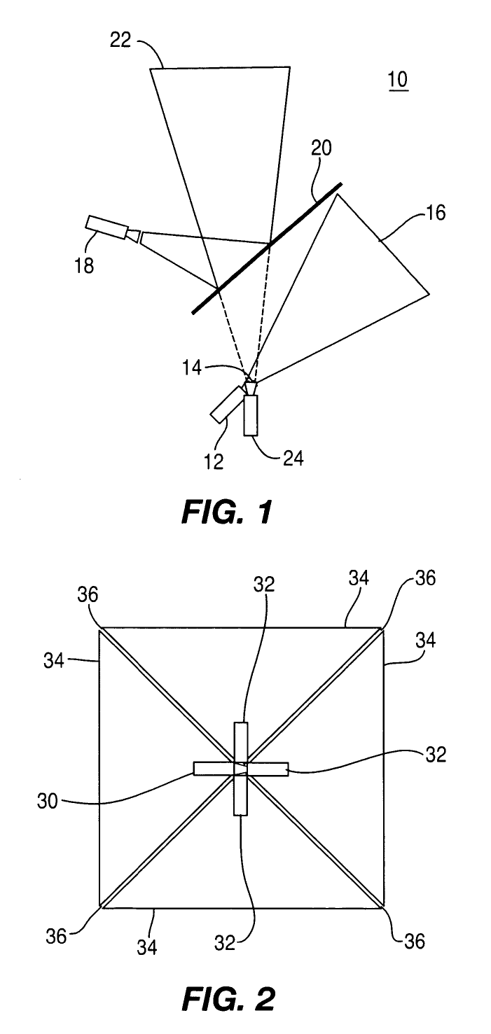

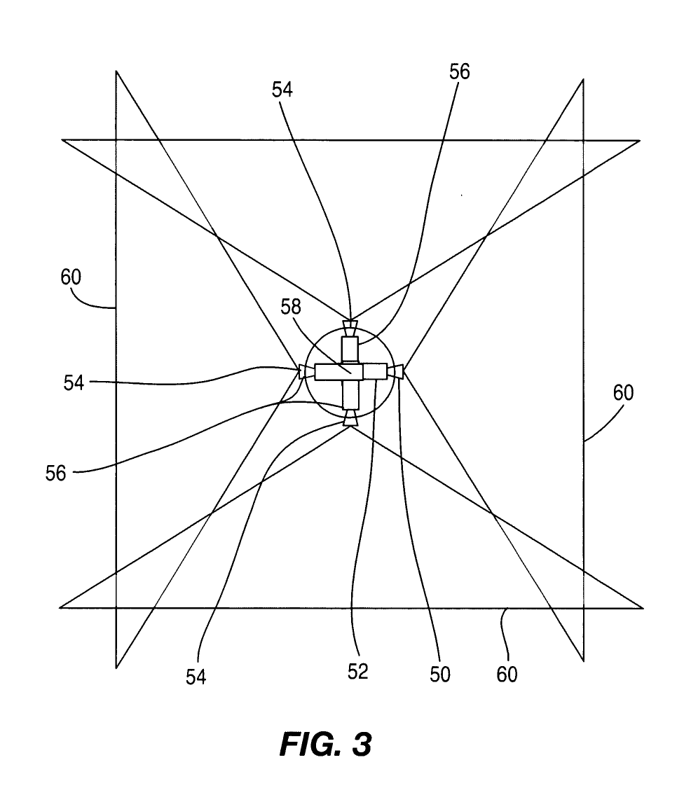

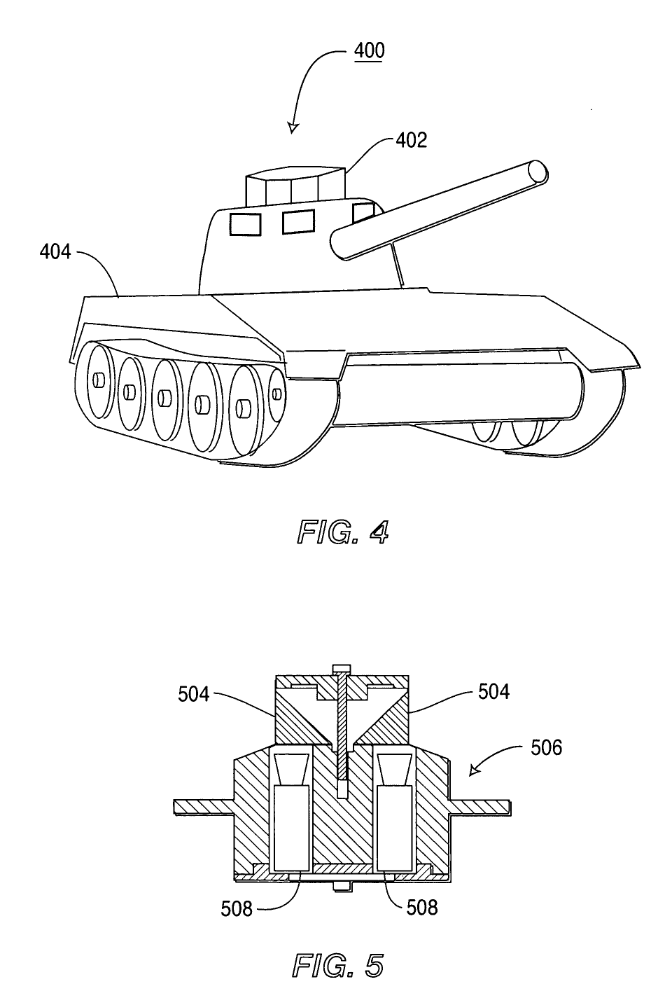

FIG. 1-2 Keyboard

FIG. 1-3 Mouse

FIG. 1-4 Joystick

FIG. 1-5 Monitor

FIG. 1-6 Storage device

FIG. 1-7 Handheld or remote control device receiver

FIG. 1-8 Internet connection

FIG. 1-9 Remote access server (RAS)

FIG. 1-10 X-Portable workstation (using some typical connection)

FIG. 1-11 Remote Control

FIG. 1-12 Unix Server

FIG. 2 is a block diagram of the X-Portable Workstation.

FIG. 2-1 Embedded Linux or another Unix base Operating System with a X-server program running on embedded device

FIG. 2-2 Modem

FIG. 2-3 LAN port or PCMCI port or any other communication port

FIG. 2-4 Infrared receiver

FIG. 2-5 Radio frequency receiver

FIG. 2-6 Optional storage device (Floppy disk or compact flash, etc)

FIG. 2-7 TV's video output

FIG. 2-8 TV's sound output

FIG. 2-9 VGA's output

FIGS. 2-10, 11 USB, PS2, RS232 or any other input/output port connector

FIG. 2-12 Joystick port connector

### DETAILED DESCRIPTION

FIG. 1. Illustrate a network according to the present invention for the point to point connection between each X-Portable Workstation 10 and the Unix server 12. The Server have a connection to the X-Portable Workstation via Remote Access Server (RAS) 9 using telephone lines or using a Internet Connection 8.The internet connection may be implemented using conventional LAN, communication techniques and protocols, such as those associated with Ethernet and other similar networks. The connection between the Unix server 12 and telephone system 9 or Internet connection 8 are not part of the invention.

The X-Portable Workstation 10 receives inputs from a Keyboard 2, a Mouse 3 and a Joystick 4. In the FIG. 1, these components are connected to the X-Portable Workstation 10 using a Universal Serial Bus (USB) connection. However, other connection techniques might be used, such as IEEE 1394 connection or wireless link to the X-Portable Workstation, such as radio frequency(RF) or infrared(IF).

The X-Portable Workstation 10 has an IR, RF, or another suitable type of detector 7 For receiving user inputs from a handheld remote control device 11.The remote control Device is used to control various function of the X-Portable Workstation 10,such as selection of connection's menu (select connections to the server),reset, etc.

The X-Portable Workstation 10 also has a video output and audio output (conventional RCA connector or A/V connectors) 1 to be connected to the television or high definition television (HDTV)

The X-Portable Workstation 10 include an optional Video Graphic Array (VGA) output 5 to be use in computer monitors.

The X-Portable Workstation 10 include an optional disk drive 6 to be use to set up the communication, storage, etc.

FIG. 2. Shows a block diagram of the X-Portable Workstation. The illustrated embodiment includes an Embedded Linux system 1, similar to the one use in the PDA (Personal Digital Assistant) enable to communicate to the server, peripheral devices and run as a Unix X-Terminal(Standard Unix graphic terminal protocol).

The Embedded Linux system 1 has connection using Embedded Linux system I/O BUS to Modem 2, Optional communication port (LAN, PCMCI, etc) 3, Infrared (IF) receiver 4, Radio Frequency (RF) receiver 5,Optional Floppy Disk 6,TV's Video output 7 (this is the graphic output from the X-Portable Workstation to the television), TV's sound output 8 (this the sound output from the X-Portable Workstation to the television sound input or any sound equipment with RCA input), Optional VGA's video output 9 (this is a graphic output compatible with computer monitors), Joystick 12, Keyboard 11, Mouse 10.

The optional Floppy disk 6 is use for set up of the box, security identification, etc.

### OPERATION OF INVENTION

In operation the X-Portable Workstation is provided to enable multiple users to access an Unix server from any location using a conventional TV when they are able to communicate to the Unix server with telephone lines, internet, etc.

### DESCRIPTION AND OPERATION OF ALTERNATIVE EMBODIMENTS

Access for users to a remote Unix computer. The user just need a television, keyboard, mouse and a connection to the remote server, eliminating the need of a personal computer to run remotely any application from the server.

Access for users to a remote Unix computer that runs as a game server. The user just needs a television, keyboard, mouse, joystick and a connection to the remote server, eliminating the need of a personal computer to run remotely any video game from the server and providing a player or multiplayer experience.

Access for users to a remote Unix computer that run as a conference server. The user just needs a television, keyboard, mouse, headset and a connection to the remote server, eliminating the need of a personal computer to run remotely a videoconference from the server and providing a way to connect multiple people to the conference base on the software implementation.

Access for users to a remote Unix computer that run as a industrial process server. The user just needs a television, keyboard, mouse and a connection to the remote server, eliminating the need of a personal computer to supervise, control and execute remotely in real time any program or data allowed by the server. In example; production of a plant, orders, checking inventories, etc.

Access for users to a remote Unix computer that run as a surveillance security server. The user just needs a television, keyboard, mouse and a connection to the remote server, eliminating the need of a personal computer to monitor the video cameras and any device connected to the remote server for the protection and security of the provider.

Access for users to a remote Unix computer that runs any remote application. This application can be under a licensee system that can be used based on a fee depending of condition prearranged between the users and providers of the application. The remote application can be of any kind; like database systems, printing, backup, financial services, games, etc.

Access for students and professors from a school, college or university to a local Unix service and a remote one to run any application owned or licensed by the University. This keep the flow of information inside of the university and eliminates the need of purchasing, installing and upgrading the same application multiple times.

Access for employees from a corporation to a local Unix service and a remote one to run any application owned or licensed by the corporation. This keep the flow of information inside of the corporation and eliminates the need of purchasing, installing and upgrading the same application multiple times.

Providers can run a Unix server for internet cafes, or any others services for public use, like wireless connection to applications with an significant reduction of cost due the lack of need of personal computers.

Access for users to new features from the entertainment industries by combining the video signal coming from a live television transmission or a video player and the video output coming from a program running in the remote server, that provides communication to online services coming from television show providers, television stations, cable companies, etc. Those remote programs can be customized to interact with the users and television shows providers, giving a new spectrum of services in the entertainment and commercialization of television shows.

### CONCLUSION RAMIFICATIONS AND SCOPE OF INVENTION

While my above description contains much specificity this should no be constitute as limitations on the scope of the invention, but rather as exemplification of one preferred embodiments thereof. Many other variations are possible. For example

The apparatus could be different size, depending on the hardware that is going to be used for the application.

The apparatus can be connected to the server using any available communication device.

The apparatus made integrally or separately (modular or in sections) can be purchase to improve the end user customization, value and performance.

The apparatus can be purchase as a part of the television set or be a part of another equipment to be used with a television as a DVD player, Video recorder system, video game system, etc.

The apparatus can receive television video signals in one of the inputs, giving the feature to the x-portable workstation to mix this television video signals with the video signal from the remote computer's program creating an effect of picture in picture, that facilitates the use of programs running in the remote computer, and allows the user to watch a television show and use a computer program running remotely at the same time. This opens a variety of services like receiving notifications of emails, news updates, stock information, etc. In the same way, the television entertainment providers can use this feature to interact with the users, by running programs in its remote computers and interchanging data or providing additional services.

What is claimed is:

1. An x-portable workstation running an X server program enables remote computer sessions to servers with x protocol, using a television device.

2. An x-portable workstation comprising:
(a) A connection using any data communications medium to a remote server with x protocol.
(b) Outputs ports for the television devices.
(c) Input ports for general input devices.
(d) Optional output port for computer monitors.
(e) An electronic embedded system running any operating system with x protocol that allows the operation of the x terminal server program referred as Linux embedded system.

3. An x-Portable workstation can use the effect of picture in picture on the television display, giving the user the ability to interact with at least two different video signals, simultaneously. One of this video signal is coming from the remote server with x protocol, and the other signal is coming from a television video source.
